(19) United States
(12) Patent Application Publication
(10) Pub. No.: US 2025/0207645 A1
(43) Pub. Date: Jun. 26, 2025

(54) Disc Brake for a Utility Vehicle, and Brake Lining for a Disc Brake for a Utility Vehicle

(71) Applicant: KNORR-BREMSE Systeme fuer Nutzfahrzeuge GmbH, Muenchen (DE)

(72) Inventors: Christian STOEGER, Muenchen (DE); Michael HIDRINGER, Muenchen (DE); Markus GERHARDINGER, Muenchen (DE)

(21) Appl. No.: 18/852,021

(22) PCT Filed: Mar. 9, 2023
(86) PCT No.: PCT/EP2023/056003

§ 371 Date: Sep. 27, 2024

(30) Foreign Application Priority Data
Mar. 30, 2022 (DE) 10 2022 107 615.6

(51) Int. Cl. F16D 65/097; F16D 65/18

(52) U.S. Cl. CPC F16D 65/097; F16D 65/18

(57) ABSTRACT

A disc brake for a utility vehicle, includes a brake caliper which engages over a brake disc and is held axially displaceable, in relation to the brake disc, on guide rods which are connected to a vehicle-side brake carrier, wherein, in the case of a braking operation, an action-side brake pad, which is mounted in the brake carrier and has a pad support plate and a friction lining fastened thereon, can be pressed against the brake disc by way of an application device which has a pivotable brake lever and at least one central brake plunger. The brake plunger has an actuating spindle and a pressure piece contacting the pad support plate. The disc brake is designed in such a manner that the pad support plate has an at least partially convex design in the contact region with the brake plunger.

### BACKGROUND AND SUMMARY

The invention relates to a disc brake for a commercial vehicle.

Disc brakes of this type are used in particular in heavy commercial vehicles, wherein the brake caliper, also referred to as sliding caliper, is fastened to a vehicle-proximal brake support by means of guide rods.

These guide rods are usually fastened by screws and guided in plain bushes of the brake caliper in such a way that the latter, during braking, is axially displaced relative to a brake disc that is held so as to be secured against rotation on an axle of the vehicle.

The force generated by a brake cylinder is positively geared by a mechanical gear unit in the interior of the brake caliper, and the brake linings (also called brake pads) are pressed in the direction of the brake disc by way of one or a plurality of brake plungers.

However, during travel, predominantly during forward travel, momentums which lead to increased wear on the lining in the form of diagonal wear on the action-proximal, that is to say application-proximal, brake lining in the region of the entry side of the brake disc occur as a result of the multiplicity of loads that arise.

Such momentums result from self-reinforcing effects, friction in the guiding of the lining, elastic deformations of the brake frame and a suboptimal introduction of force, this leading to a non-uniform distribution of pressure on the friction lining.

The weight of the brake cylinder held on the brake caliper also contributes toward the non-uniform loading of the action-proximal brake lining, this arising in particular in the case of a brake application device which has a central brake plunger that is aligned so as to be axially parallel to the rotation axis of the brake disc.

This diagonal wear results in a raft of disadvantages in terms of the operation of the disc brake as well as in terms of the service life of the brake linings.

The mentioned momentums with a detrimental effect overall ultimately have the result that the action-proximal brake lining is non-uniformly loaded during braking, so that the braking effect is not achieved to the potential degree, this resulting in the diagonal wear mentioned.

This also leads to at least the action-proximal brake lining having to be prematurely replaced because the entry-side region of the brake lining has already reached a permissible critical wear while the opposite region, thus the exit-side region, has not yet reached the critical wear.

The invention is based on the object of refining a disc brake of the generic type in such a way that the service life of the brake linings is in particular increased and the operation costs are thus reduced and the functional reliability is improved.

This object is achieved by a disc brake having the features of the independent claim(s).

As has been demonstrated, it is achieved by this design embodiment of the lining support plate that the application-proximal brake lining in the event of braking is pressed against the brake disc so that the contact pressure is distributed equally across the friction face. The effective momentums overall are positively influenced, and homogenous wear on the linings is achieved.

In principle, the arrangement of the brake plunger known from the prior art is refined by the invention in such a way that during braking the pressure point, i.e. the bearing action of the brake plunger on the lining support plate, bears on the lining support plate at a spacing from the central axis of the brake plunger.

In the design embodiment according to the invention, as per which the lining support plate is at least partially of a convex design in the contact region with the brake plunger, the brake plunger rolls on the molded contact region of the lining support plate as soon as diagonal wear is generated and the assigned brake lining rotates. The position of the pressure point changes in the process, and a momentum about the transverse axis of the lining support plate that counteracts the momentum causing the diagonal wear is created.

The traveling mode of the commercial vehicle is predominantly in the forward direction, wherein the diagonal wear is created on the entry side of the brake lining, as a result thereof rotating onward in the clockwise direction.

Despite optimal activation of the disc brake and of the offset of the pressure point, for example, environmental influences, in particular corrosion, or the driving operation per se, can change the conditions in such a manner that the originally predicted assumption is no longer valid and diagonal wear is created yet again.

Owing to the convex shape of the contact region of the lining support plate, the brake plunger rolls on the latter, as a result of which a larger offset of the pressure point from the central axis of the brake plunger is formed and an effective compensating momentum increases. This results in increased wear of the brake lining on the exit-proximal lining half, and consequently in a homogenous overall wear on the friction lining.

Diagonal wear, specifically on the exit side, is also created when the commercial vehicle reverses. Here too, the brake lining rotates but in the counter-clockwise direction, this resulting in a smaller offset which likewise reduces the effective compensating momentum. This results in increased wear of the friction lining on the entry-proximal friction lining half, and consequently in a homogenous overall wear on the brake lining.

The sensitivity of the response of the system can be specified by a corresponding design of the geometry of the contact region.

In this way, the base area of the contact region can be circular; or else other shapes such as an oval or an ellipse are contemplated. According to a further concept, the contact region has a planar face which laterally transitions into the convex shape in the region of the pressure point.

Moreover, a geometry in which the contact region has an arcuate portion with a small radius on the entry side, and such an arcuate portion with a larger radius on the exit side is contemplated. An alternative thereto is a combination of a circular path and an ellipse. It is to be assumed in principle that a circle with a small diameter leads to a minor offset, and a circle with a large diameter leads to a large offset at a defined oblique position of the friction lining.

Apart from compensating a tangential diagonal wear, it may also be necessary to compensate a radial diagonal wear of the friction lining. The cause for this may lie in the dead weight of the disc brake, which acts in different directions depending on the assembled position on the vehicle.

Moreover, a radial diagonal wear is caused by different relative speeds between the inner and the outer region on the brake caliper.

The compensation of a radial diagonal wear herein can also take place in that the convex geometry is at an acute angle in relation to the transverse axis of the brake lining, specifically with a consistent width in the profile, wherein the angle is approximately 15 to 30° in relation to the transverse axis.

Other shapes, for example conical shapes, of the convex contact region can also be inclined at this angle, proceeding from a region that faces the upper edge of the lining support plate so as to taper toward a region that faces the lower edge. In any case, a symmetry axis of the convex contact region runs through the imaginary center of the lining support plate.

Further advantageous configurations of the invention are characterized in the dependent claims.

Exemplary embodiments of the invention will be described hereunder by means of the appended drawings.

### BRIEF DESCRIPTION OF THE DRAWINGS

FIG. 1 shows a disc brake according to the prior art in a partially sectional plan view;

FIG. 2 shows a brake lining of the disc brake according to an embodiment of the invention in a perspective rear view;

FIGS. 3 to 5 show, in each case, a brake lining according to an embodiment of the invention in different operating positions in a schematic plan view;

FIG. 6 shows a further exemplary embodiment of the brake lining according to the invention in a sectional plan view, in a schematic illustration;

FIG. 7 shows the brake lining in a perspective sectional illustration; and

FIGS. 8 and 9 show, in each case, an exemplary embodiment of the brake lining according to the invention, in a rear view.

### DETAILED DESCRIPTION OF THE DRAWINGS

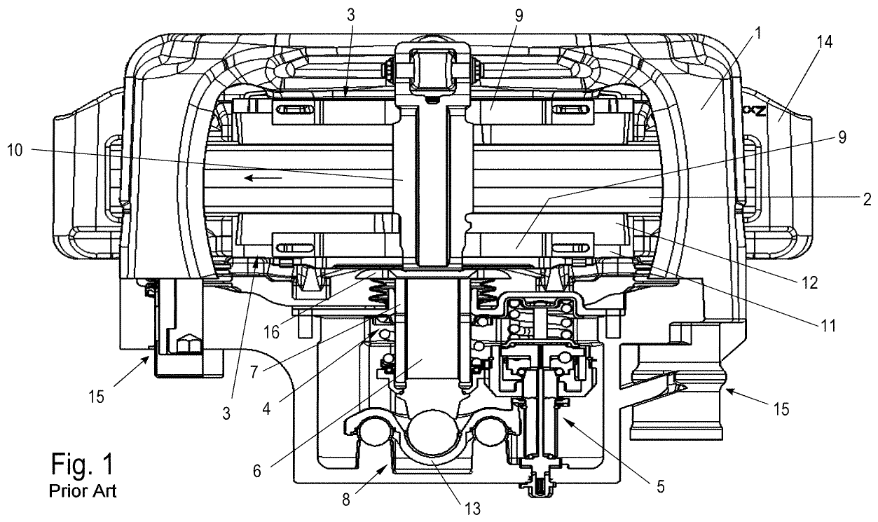

Illustrated in a schematic illustration in FIG. 1 is a disc brake according to the prior art, having a brake caliper 1 which straddles a brake disc 2, is designed as a sliding caliper and in which two brake linings (brake pads) 3 are disposed.

During braking, these brake linings 3 are able to be pressed against the rotating brake disc 2, wherein the rotating direction of the brake disc 2 during forward travel is identified by an arrow.

During braking, the application-proximal brake lining 3 is first pressed against the brake disc 2 by means of a brake application device 8, while the reaction-proximal brake lining 3 is subsequently pressed against the brake disc 2 by virtue of the reactive forces due to the entrainment of the brake caliper 1 being displaced.

Each brake lining 3 consists of a lining support plate 11 and a friction lining 12 which is fastened thereto and during braking bears in a rubbing manner on the brake disc 2.

A lining retaining spring 9 which, when interacting with a holding bracket 10, holds the brake linings 3 so as to be pre-loaded in a brake shaft of the brake caliper 1 or of a vehicle-proximal brake support 14, is in each case fastened to the lining support plates 11.

The brake caliper 1 is mounted on guide rods 15, which are connected to the brake support 14, so as to be axially displaceable relative to the rotation axis of the brake disc 2.

The brake application device 8 has a brake plunger 4 which is centrally disposed and by way of a brake lever 13 is able to be pressed in an axially displaceable manner against the application-proximal brake lining 3, wherein the brake lever 13 bears on the brake plunger 4 by way of a bearing ball.

The brake plunger 4 consists of a threaded spindle 6 to which a readjustment device 5 for compensating a clearance is connected, and of an actuating spindle 7 which is designed as a threaded bush and by way of an internal thread engages in an external thread of the threaded spindle 6, and which by way of the end side thereof that faces the lining support plate 11 of the application-proximal brake lining 3 is fixedly connected to a compression piece 16 which bears on the lining support plate 11 so as to be secured in the rotating direction in such a way that the actuating spindle 7 is held so as to be secured against rotation.

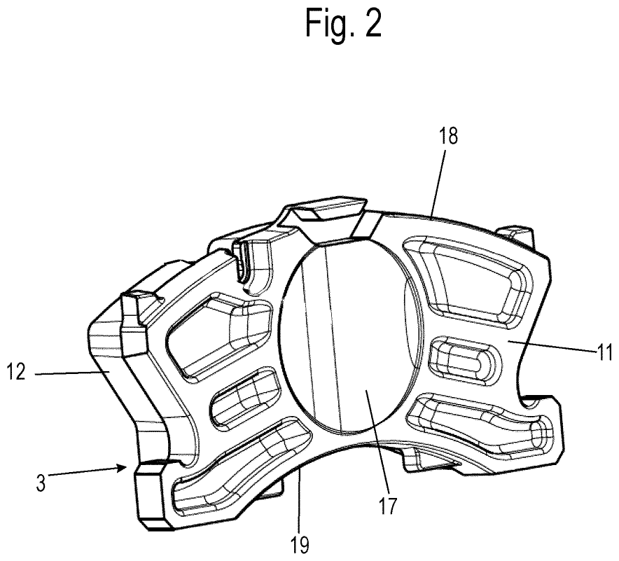

Illustrated in FIG. 2 is an application-proximal brake lining 3 according to an embodiment of the invention having, for example, a circular contact region 17 which, according to the invention, is at least partially of a convex design and on which the brake plunger 4 by way of its compression piece 16 bears during operation. This contact region 17 herein is provided on the rear side of the lining support plate 11 that faces away from the friction lining 12, wherein said lining support plate is delimited by an upper edge 18 and an opposite lower edge 19.

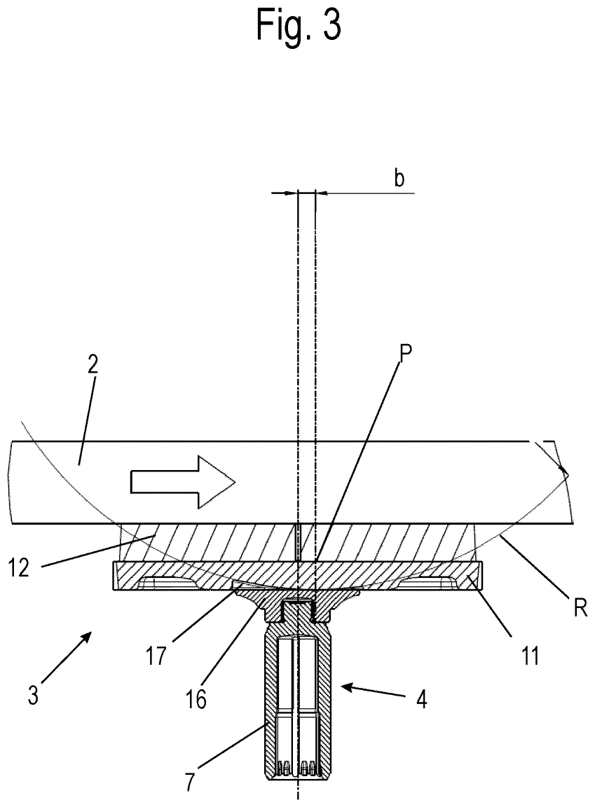

Depicted in FIG. 3 is the application-proximal brake lining in a position in which the friction lining 12 contacts the brake disc 2, but in which no diagonal wear is yet present.

The convexly molded contact region 17 herein is displaced by the value b in the rotating direction of the brake disc 2, which is identified by an arrow, so as to avoid the occurrence of tangential diagonal wear. The value b, which is moreover determined by computation, by simulation, or by experiments, is defined herein by the spacing between the pressure point P on the convexly curved contact region 17 and the central axis of the brake plunger 4.

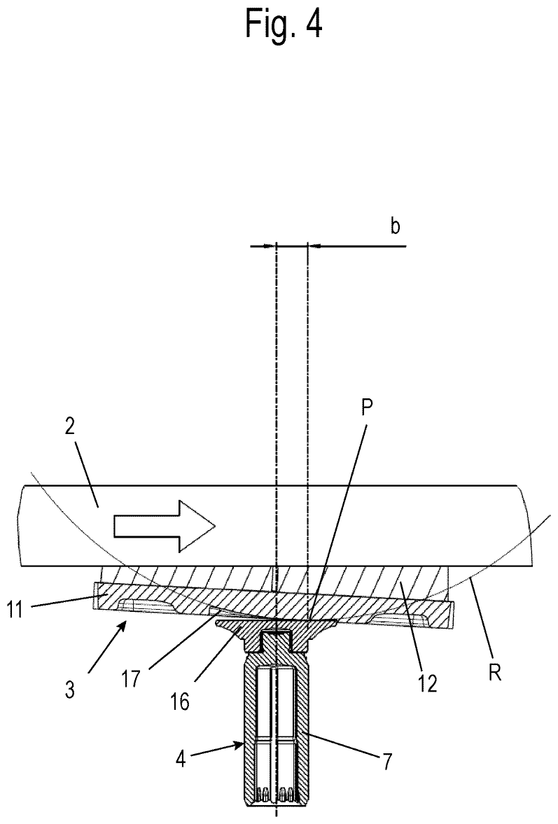

Depicted in FIG. 4 is a diagonal wear of the friction lining 12 on the entry side of the brake disc 2, wherein the brake lining 3 twists in the clockwise direction.

The brake plunger 4 herein rolls on the convex contact region 17, which is curved arcuately with the radius R, and a larger spacing b is created, as a result of which the effective compensating momentum increases.

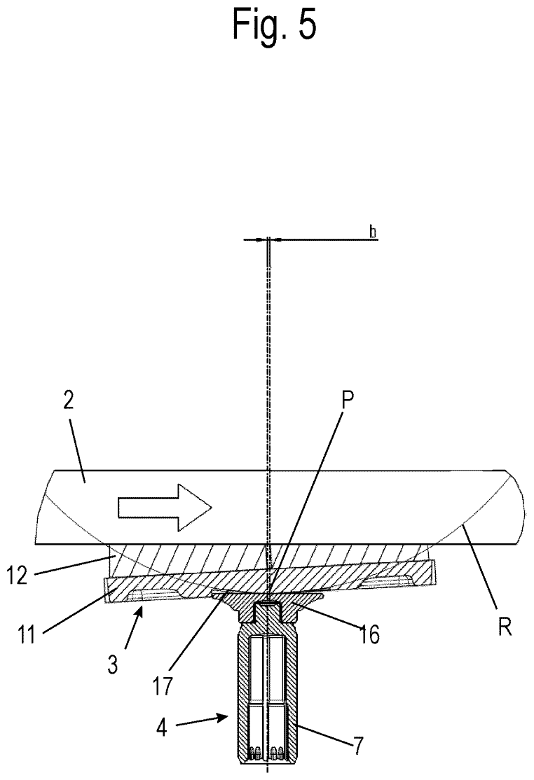

To be seen in FIG. 5 is a position of the brake lining 3 in which the diagonal wear of the friction lining 12 enters on the exit side, whereby the brake lining 3 here however twists in a counter-clockwise manner, with the consequence of a smaller spacing b, wherein the effective compensation momentum is likewise reduced. As a result, increased wear on the friction lining 12 on the entry side is achieved, this leading to a homogenous overall wear on the brake lining 3.

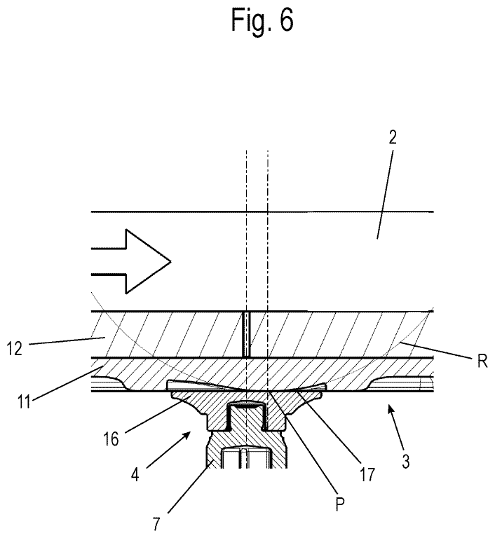

The convex contact region 17 can be particularly clearly seen in FIG. 6 which reproduces a friction lining 12 without diagonal wear, wherein the convex portion with the radius R extends only across a sub-region of the contact region 17.

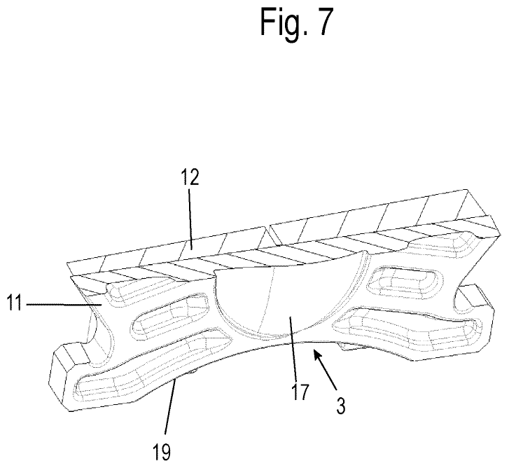

FIG. 7 shows a brake lining 3 in a longitudinal section, having a convex contact region 17 corresponding to that shown in FIG. 6.

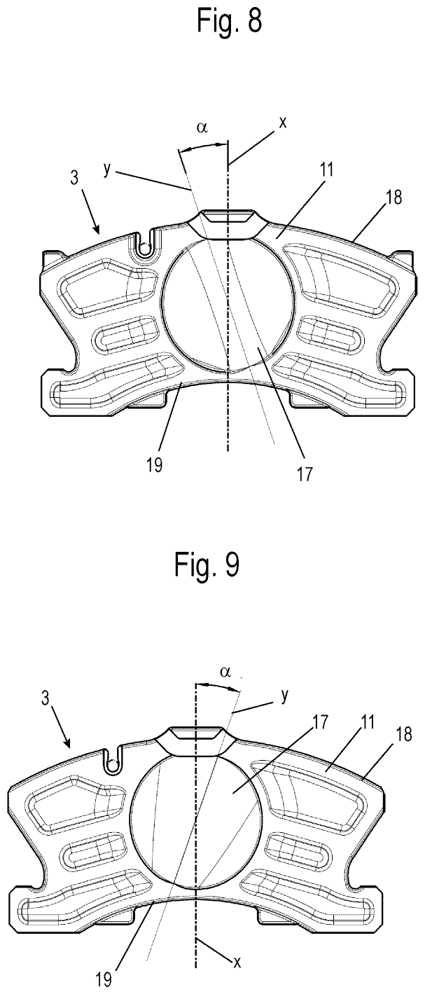

FIG. 8 depicts the brake lining 3 in a rear view, in which the convex contact region 17 is designed at an angle α in relation to a transverse axis X, wherein the contact region 17 is designed with the same width throughout, and its symmetry axis Y runs through the imaginary center of the lining support plate 11. In the example, the curved contact region 17 is inclined so as to ascend toward the entry side.

A further variant of the convex contact region 17 is shown in FIG. 9, which proceeding from the side that faces the upper edge 18 tapers toward the lower edge 19, wherein the symmetry axis Y likewise runs at an angle α in relation to the transverse axis X, but is directed toward the exit side.

As a result of the shaping shown in FIGS. 8 and 9, apart from the compensation of a tangential diagonal wear, the compensation of a radial diagonal wear can also be achieved.

### LIST OF REFERENCE SIGNS

1 Brake caliper
2 Brake disc
3 Brake lining (pad)
4 Brake plunger
5 Readjustment device
6 Threaded spindle
7 Actuating spindle
8 Brake application device
9 Lining retaining spring
10 Holding bracket
11 Lining support plate
12 Friction lining
13 Brake lever
14 Brake support
15 Guide rod
16 Compression piece
17 Contact region
18 Upper edge
19 Lower edge
P Pressure point
X Transverse axis
Y Symmetry axis

1.-10. (canceled)

11. A disc brake for a commercial vehicle, comprising:
a brake caliper which straddles a brake disc and, relative to the brake disc, is held so as to be axially displaceable on guide rods connected to a vehicle-proximal brake support;
a brake lining which, during braking, is proximal to an action of force and mounted in the brake support, the brake lining comprising a lining support plate and a friction lining fastened thereto;
a brake application device by which the brake lining is pressable against the brake disc, the brake application device comprising a pivotable brake lever and at least one brake plunger,
wherein the brake plunger has an actuating spindle and a compression piece that contacts the lining support plate, and
wherein the lining support plate has an at least partially convex design in a convex contact region with the brake plunger.

12. The disc brake as claimed in claim 11, wherein
a pressure point of the brake plunger on the convex contact region is positioned so as to be spaced apart from a longitudinal axis of the brake plunger.

13. The disc brake as claimed in claim 12, wherein
the pressure point is positioned in an egress direction so as to be spaced apart from the longitudinal axis of the brake plunger.

14. The disc brake as claimed in claim 11, wherein
the convex contact region is arcuate at least in a rotating direction of the brake disc.

15. The disc brake as claimed in claim 11, wherein
the convex contact region is circular, oval or elliptic.

16. The disc brake as claimed in claim 11, wherein
the convex contact region centrically has a planar face.

17. The disc brake as claimed in claim 11, wherein
the convex contact region, on an entry side, has a circular shape with a small radius, and, on an exit side, has a circular path with a larger radius.

18. The disc brake as claimed in claim 11, wherein
the convex contact region is designed in the shape of a strip and aligned at an angle in relation to a transverse axis.

19. The disc brake as claimed in claim 11, wherein
the convex contact region is aligned in a direction of a lower side of the lining support plate so as to taper at an angle in relation to a transverse axis.

20. A brake lining for a disc brake for a commercial vehicle, comprising:
a lining support plate; and
a friction lining fastened to the lining support plate,
wherein the lining support plate, on a rear side thereof facing away from the friction lining, has a contact region for a brake plunger of the disc brake, and
wherein the contact region is at least partially of a convex design.
